(19) United States
(12) Patent Application Publication
(10) Pub. No.: US 2005/0019623 A1
(43) Pub. Date: Jan. 27, 2005

(54) Combustor, fuel reforming device, fuel cell system and method for starting up the fuel reforming system

(76) Inventors: Tadashi Shoji, Yokosuka-shi (JP); Koichi Yamaguchi, Yokohama (JP); Shiro Tanaka, Yokosuka (JP); Hisashi Mitsumoto, Ebina (JP)

Correspondence Address: Richard L Schwaab;Foley & Lardner, Suite 500, 3000 K Street N W, Washington, DC, 20007-5109, US

(21) Appl. No.: 10/493,243

(22) PCT Filed: May 29, 2003
(86) PCT No.: PCT/JP03/06767

(30) Foreign Application Priority Data
Jun. 3, 2002 (JP) 2002-161629

(51) Int. Cl. H01M 8/06; F23D 11/44; F23D 14/62

(52) U.S. Cl. 429/17; 429/20; 422/198; 431/354; 431/217

(57) ABSTRACT

A combustor (BR) is provided with a premixer (10) mixing fuel and heating gas, a mixer (8) combusting the fuel and the heating gas mixed in the premixer, and a porous medium (9) disposed between the premixer and the mixer. A reformer (2) can be disposed downstream of the combustor, with the combustor and the reformer forming a fuel reforming device (R). Also, a fuel cell (1) can he disposed downstream of the reformer to form a fuel cell system (S), with the fuel reforming device.

### TECHNICAL FIELD

The present invention relates to a combustor, a fuel reforming device, a fuel cell system and a related method and, more particularly, to a combustor that forms homogeneous mixture gas by premixing liquid fuel and heating gas, a fuel reforming device and a fuel cell system using such a combustor, and a related method.

### BACKGROUND ART

A fuel cell is based on a principle in that electrochemical reaction takes place between hydrogen, serving as fuel, and oxygen contained in air through an electrolyte for directly generating electric power. For this reason, a conversion of an energy form required in other electric power generating systems do not take place in such a fuel cell, and therefore its electric power generation can be carried out at a high efficiency.

A hydrogen supply source may include a pure hydrogen source and, in addition thereto, may utilize hydrogen-rich gas resulting from reforming reaction of hydrocarbon series fuel such as hydrocarbon and alcohol.

The reforming reaction may be classified into partial oxidizing reaction and steam reforming reaction, or auto-thermal reaction in combination of these reactions. Since feed fuels for reforming may possibly include not only gas-phase hydrocarbon such as methane, ethane and propane but also liquid-phase hydrocarbon such as gasoline and methanol, the reforming reaction takes the form of gas-phase reaction and so fuel should be gasified. In any way, reaction does not proceed under a room temperature. Although the reaction temperature is dependent upon reforming fuel, in general, the temperature of a fuel reformer is required to rise at a value beyond 500° C.

Thus, since the temperature of the fuel reformer is required to increase at a given temperature in order to promote the reforming reaction, if a fuel cell of a fuel reforming type is utilized as an energy source of a vehicle such as an automobile with a large number of times in startup and stoppage, it is important to shorten its worming-up time.

Japanese Patent Application Laid-Open Publication No. 2000-63105 discloses a fuel reforming device. Such a fuel reforming device includes a startup combustor mechanism that combusts feed fuel at a startup, so as to generate combustion gas for heating a reforming catalyst section of the fuel reforming device.

### DISCLOSURE OF INVENTION

However, upon considerable studying works conducted by the present inventors, during a startup of such a reformer, since liquid feed fuel such as methanol is sprayed to allow fuel to be mixed with air to achieve diffusion combustion, there is a tendency in that locally different air-fuel ratios occur to result in combustion temperatures distributed at high temperatures. As the combustion temperature increases, nitrogen oxides are generated. As a consequence, it is conceived that a long term warming up of the reformer for the diffusion combustion of the fuel results in an increase in the amount of production of nitrogen oxides.

The present invention has been completed upon the above studies conducted by the present inventors and has an object to provide a combustor, a fuel reforming device, a fuel cell system and a related method to restrain the amount of production of nitrogen oxides.

To achieve such an object, one aspect of the present invention provides a combustor comprising: a premixer mixing fuel and heating gas; a mixer combusting the fuel and the heating gas mixed in the premixer; and a porous medium disposed between the premixer and the mixer, the fuel and the heating gas mixed in the premixer being supplied to the mixer through the porous medium.

Further, another aspect of the present invention provides a fuel reforming device comprising: a premixer mixing fuel and heating gas; a mixer combusting the fuel and the heating gas mixed in the premixer; a porous medium disposed between the premixer and the mixer, the premixer, the fuel and the heating gas mixed in the premixer being supplied to the mixer through the porous medium, and the mixer and the porous medium forming a first combustor; and a reformer disposed downstream of the first combustor for generating hydrogen-rich gas.

Furthermore, another aspect of the present invention provides a fuel cell system comprising: a premixer mixing fuel and heating gas; a mixer combusting the fuel and the heating gas mixed in the premixer; a porous medium disposed between the premixer and the mixer, the fuel and the heating gas mixed in the premixer being supplied to the mixer through the porous medium, and the premixer, the mixer and the porous medium forming a first combustor; a reformer disposed downstream of the first combustor for generating hydrogen-rich gas; and a fuel cell disposed downstream of the reformer.

On one hand, another aspect of the present invention provides a method of starting up a fuel cell system, comprising: providing a fuel cell system equipped with a premixer mixing fuel and heating gas, a mixer combusting the fuel and the heating gas mixed in the premixer, a porous medium disposed between the premixer and the mixer, a reformer disposed downstream of the mixer to produce hydrogen-rich gas and a fuel cell disposed downstream of the reformer; warming up the porous medium by achieving diffusion combustion between the fuel and air in the premixer and, subsequently, interrupting the diffusion combustion; and warming up the reformer by combusting the fuel and the heating gas in the mixer, while supplying the fuel and the heating gas into the mixer through the premixer and the porous medium.

Other and further features, advantages, and benefits of the present invention will become more apparent from the following description taken in conjunction with the following drawings.

### BRIEF DESCRIPTION OF DRAWINGS

FIG. 1 is a view illustrating a structure of a combustor, a fuel reforming device and a fuel cell system of a first embodiment according to the present invention;

FIG. 2 is a flowchart illustrating an operating method for starting up the fuel cell system of the first embodiment;

FIG. 3 is a view illustrating a structure of a combustor, a fuel reforming device and a fuel cell system of a second embodiment according to the present invention;

FIG. 4 is a view illustrating a structure of a combustor, a fuel reforming device and a fuel cell system of a third embodiment according to the present invention;

FIG. 5 is a view illustrating a structure of a combustor, a fuel reforming device and a fuel cell system of a fourth embodiment according to the present invention; and

FIG. 6 is a view illustrating a structure of a combustor, a fuel reforming device and a fuel cell system of a fifth embodiment according to the present invention.

### BEST MODE FOR CARRYING OUT THE INVENTION

Hereinafter, a combustor, a fuel reforming device, a fuel cell system and a related method of each embodiment according to the present invention are described in detail with suitable reference to the drawings.

(First Embodiment)

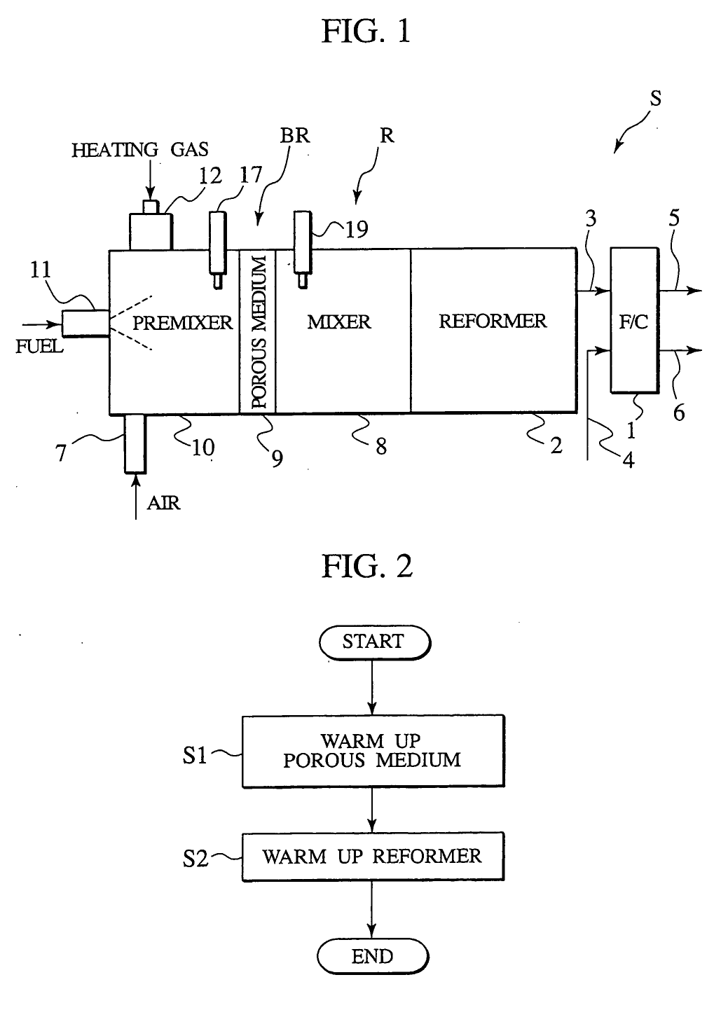

First, a combustor, a fuel reforming device, a fuel cell system and a related method of a first embodiment according to the present invention are described in detail in conjunction with FIGS. 1 and 2.

FIG. 1 is a view illustrating a structure of the fuel cell system equipped with the combustor and the fuel reforming device of the presently filed embodiment.

In FIG. 1, a fuel cell system S of a fuel reforming type is comprised of a fuel cell 1 equipped with an anode (fuel electrode: not shown) and a cathode (oxidizing electrode: not shown) to form a fuel cell main body, a reformer 2 that generates hydrogen-rich reformed gas to be supplied to the fuel cell 1, a reformed gas supply line 3 that supplies the reformed gas to the fuel cell 1 from the reformer 2, an air supply line 4 that supplies air from an air compressor, not shown, to the fuel cell 1, an anode exhaust gas line 5 that emits exhaust gases from the anode of the fuel cell 1, a cathode exhaust gas line 6 that emits exhausted air from the cathode of the fuel cell 1, an air supply port 7 that supplies air to the premixer 10, a mixer 8 that allows the fuel, the air and the like, premixed in the premixer 10, to be mixed, a porous medium 9 that is disposed between the premixer 10 and the mixer 8, the premixer 10 that premixes the fuel, the air and the like, a fuel supply unit 11 that injects the liquid fuel to the premixer 10, a heating gas intake port 12 that introduces heating gas into the premixer 10, an igniter source-A 17 that ignites flammable gas in the premixer 10, and an igniter source-B 19 that ignites flammable gas in the mixer 8.

That is, disposed between the premixer 10 and the mixer 8 is the porous medium 9, with a section covering the premixer 10, the porous medium 9 and the mixer 9 forming a combustor BR. The reformer 2 is located downstream of such a combustor to allow the hydrogen-rich reformed gas, produced by the reformer 2, to be supplied to the fuel cell 1 via the reformed gas supply line 3. A section covering the combustor BR and the reformer 2 forms a fuel reforming device R.

The porous medium 9 is comprised of a structure including at least one of a foamed body, a sintered body, a fine-wire aggregate body and a honeycomb structural body. More particularly, the porous medium 9 includes at least one of the foamed body such as metal-foamed material or ceramic foamed material, the sintered body composed of metal or ceramic powder, the fine-wire aggregate body composed of steel wool and other finely wired metal and formed by a stack or compression thereof, and the honeycomb structured body composed of metallic material.

The fuel to be supplied from the fuel supply unit 11 to the premixer 10 corresponds to feed fuel for reforming and includes hydrogen, with hydrocarbon or water being used for this purpose.

On the other hand, the heating gas is supplied from the heating gas intake port 12 and mixed with the fuel and the air in the premixer 10. In particular, the heating gas to be introduced into the premixer 10 is composed of high temperature gas that includes exhaust gases (combustion gas) which are obtained by combusting off-gases of the fuel cell 1 or air which is heat-exchanged with such exhaust gases, so as to apply heat to the fuel and the air introduced into the premixer 10. Of course, the high temperature gas may include not only such exhaust gases or air but also compressed gas heat-exchanged with the exhaust gases or the off-gas per se of the fuel cell.

By the way, in a case where the fuel is composed of the liquid fuel, if the heating gas remains at a sufficiently high temperature and no limitation occurs in a size of the premixer, it is possible for the premixer, as it originally stands, to achieve adequate vaporization and mixing of the fuel and the air. However, with such a structure, there exists a probability in that the premixer tends to inevitably increase in size and, also, a difficulty is encountered in obtaining homogeneous mixture gas because of the gas diffusion speed.

Here, the presently filed embodiment has a structure in that the fuel and the heating gas is premixed in the premiser 10. In the existence of such a structure, even if the liquid fuel cannot be completely vaporized, non-vaporized liquid fuel is trapped in the porous medium 9 at once and then vaporized. Consecutively, turbulent flow is formed by the porous medium 9, resulted in promoted diffusion of the mixture gas which has been previously premixed. Then, the mixture gas containing the fuel and the heating gas emitting from the porous medium 9 forms homogeneous mixture gas which in turn is supplied to the reformer 2. That is, the porous medium 9 has a function to achieve the homogenizing of the mixture gas and the vaporizing of the fuel and has a capability of achieving remarkable reduction in size of the premixer 10.

Now, an operating method of starting up the fuel cell system of the reforming type of the presently filed embodiment in the structure set forth above is described below with reference to FIG. 2.

FIG. 2 is a flowchart illustrating a basic sequence of the operating method of starting up the fuel cell system of the reforming type of the presently filed embodiment. Also, such a basic sequence of operations is executed by a controller, which is not shown, of the fuel cell system.

First, a series of steps are started up, in step S1, heating combustion is carried out for heating and warming up the porous medium 9. Namely, the air is supplied from the air supply port 7 into the premixer to which the liquid fuel is also injected by the fuel supply unit 11 to form the mixture gas whereupon the mixture gas is ignited in the premixer 10 by the igniter source-A 17 to initiate the diffusion combustion in the premixer 10, thereby heating the porous medium 9. Supposed that the temperature required for vaporizing the fuel is 300° C., the diffusion combustion is continued until the porous medium 9 reaches 300° C. and, at a timing at which the temperature reaches 300° C., the supply of the fuel and the air is interrupted once to interrupt the diffusion combustion in the premixer 10. Also, the igniter source-A 17 may include a glow plug or a spark plug.

Subsequently, in step S2, the porous medium 9 and the mixer 8 achieve the pre-evaporation and premixed combustion to warm up the reformer 2. That is, the liquid fuel is injected into the premixer 10 from the fuel supply unit 11 to which the air is also supplied through the air supply port 7 and the high temperature heating gas is introduced through the heating gas intake port 12. Since such fuel that is supplied is the liquid fuel, the liquid fuel takes the heats away from the heating gas, which is the high temperature gas, and from porous medium 9, respectively, and is vaporized for generating the homogeneous mixture gas at a downstream of the porous medium 9. Then, this mixture gas is ignited by the igniter source-B 19, thereby enabling the combustion of the mixture gas in the mixer 8. And, in addition, this combustion gas is supplied to the reformer 2, thereby heating and warming up the reformer 2.

Namely, here, since the premixer 10 achieving the premixture of the fuel and the air while compelling the high temperature heating gas to act thereon, the porous medium 9 is able to obtain the homogeneous air-fuel mixture. Then, the mixture gas is ignited by the igniting source-B 19 to obtain the combustion gas. When in such combustion, since the homogeneously mixed gas is ignited and no irregularity in the combustion temperature takes place to avoid the high temperature increase that would locally cause the formation of NOx, an advantageous feature results in an ease of controlling exhaust gas composition, such as, the reduction of NOx in the exhaust gases. Also, the glow plug or the spark plug can be applied to the igniter source-B 19 like the igniter source-A 17. Moreover, by locating an additional porous medium in the mixer 8 or just downstream thereof in order to block formation of combustion flame, a distance between the combusting section and the reformer 2 can be further shortened.

In particular, in a case where the reformer achieves the reforming reaction at 500° C., the above-described pre-evaporated and premixed combustion are continued until the reforming temperature reaches 500° C. and, at the temperature of 500° C., the supply of the fuel and the air are interrupted once to stop combustion, thereby terminating the series of the steps. Also, thereafter, the operation proceeds to a normal operation mode.

That is, in the fuel cell system of the presently filed embodiment, after the reformer 2 has been adequately warmed up at a given temperature, the operation proceeds to the normal operation mode. During such normal operation mode, the fuel is supplied into heating gas in the premixer 10 to allow the fuel to be adequately vaporized by the premixer 10 and the porous medium 9 and, thereafter, the reforming is performed in the reformer 2.

Upon initiating the normal operation in such a sequence of the fuel cell system set forth above, especially, after completing the startup operations of the porous medium 9 and the reformer 2, it becomes possible to minimize the diffusion combustion that would generate a large amount of the nitrogen oxides while, concurrently, warming up the fuel cell system in a rapid fashion.

Further, in case of fuel being composed of the liquid fuel, the use of a fuel injection valve as the fuel supply unit 11 provides an ease of mixing the fuel with the air. Furthermore, a two-fluid type fuel injection valve combining the fuel supply unit and the air supply unit may be employed and, in such a case, the liquid droplets of the fuel are further finely formed and have an ease of mixing capability with the air. The glow plug or the spark plug may be suited as the igniter source-A 17 and the igniter source-B 19 in view of improved cost performance.

With the presently filed embodiment mentioned above, due to an ability of obtaining the pre-evaporated and premixed, homogeneous air-fuel mixture at an area downstream of the porous medium, since the pre-evaporated and premixed combustion takes place with no locally distributed high temperature regions, it is possible to reduce the NOx content, which would occur during the combustion, to a lower value than that attained during the diffusion combustion where the combustion of the injected fuel takes place.

Further, since, after the porous medium has been heated and warmed up during the diffusion combustion in the preliminary stage, the heating gas and the fuel are supplied to the premixer and the operation proceeds to the pre-evaporation and premixed combustion, the premixer and the porous medium are able to achieve the pre-evaporation and premixing of the fuel and the high temperature gas, enabling the mixer to immediately shift to the pre-evaporated and premixed combustion.

Furthermore, when warming up the reformer, since the rate at which such pre-evaporated and premixed combustion takes place increases, the amount of NOx to be generated can be eliminated.

In addition, because of an ability of using the combustor, which warms up the reformer, as such an evaporator for mixing the fuel and the heating gas, or for vaporizing and mixing the fuel, the heating gas and the air, the number of component parts of an entire fuel cell system can be minimized.

(Second Embodiment)

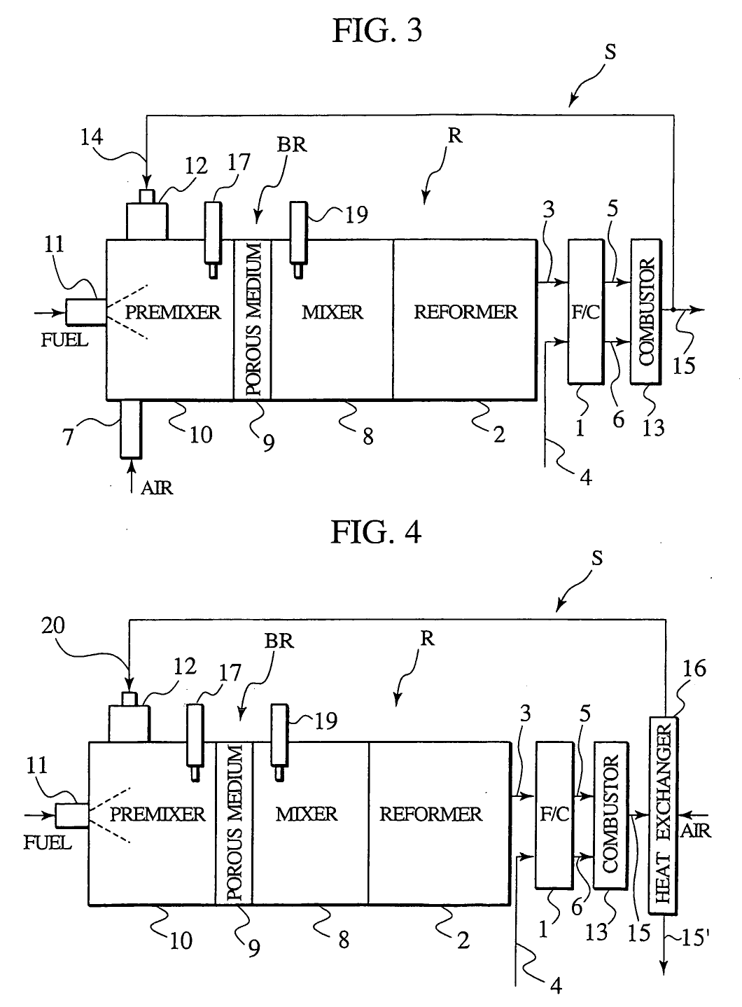

Next, a combustor, a fuel reforming device, a fuel cell system and a related method of a second embodiment according to the present invention are described in detail mainly in conjunction with FIG. 3.

FIG. 3 is a view illustrating a structure of the fuel cell system equipped with the combustor and the fuel reforming device of the presently filed embodiment.

In FIG. 3, a different point between the presently filed embodiment and the first embodiment resides in a structure that additionally includes a second combustor 13, for combusting the exhaust gases emitted from the fuel cell 1, which is disposed in a downstream stage of the fuel cell 1, a combustion gas recirculation line 14 which guides combustion gas combusted in the combustor 13 into the heating gas intake port 12 of the premixer 10, and a combustion exhaust gas line 15 which expels the combustion gas from the combustor 13 to outside. The presently filed embodiment is similar in other structure with the first embodiment and, so, like parts bear the same reference numerals to omit redundant description. Also, the startup method of the fuel cell system of the presently filed embodiment is similar to that of the first embodiment.

In particular, the presently filed embodiment takes the form of a structure that utilizes combustion gas, containing residual hydrogen expelled from the fuel cell 1, as the heating gas. The fuel cell 1 and the combustor 13 are connected to one another through the anode exhaust gas line 5 and the cathode exhaust gas line 6 through which the anode exhaust gas (off-gas) and the cathode exhaust gas (off-gas) are supplied, respectively. Here, in general, since it is hard for the fuel cell to oxidize a whole amount of hydrogen supplied to the anode, the anode exhaust gas contains the hydrogen and the steam that are not utilized in the fuel cell. Therefore, the combustor 13 is able to combust the hydrogen contained in the anode exhaust gas and the oxygen contained in cathode exhaust gas, thereby enabling the combustion gases to be formed as the heating gas. And, at least a part of the combustion exhaust gases emitted from such a combustor 13 is introduced from the heating gas intake port 12 into the premixer 10 through the combustion gas recirculation line 14. Also, the residual combustion gases are exhausted through the combustion gas exhaust line 15.

According to the presently filed embodiment set forth above, due to an ability of combusting the hydrogen in the exhaust gases to obtain the heating gas, there is no need for an external energy for generating heating gas, resulting in a capability for improving an efficiency of the fuel cell system.

Further, when performing steam reforming by the reformer, the exhaust gases contain the moisture and, hence, it is able to supply such moisture to the reformer for the steam reforming.

(Third Embodiment)

Next, a combustor, a fuel reforming device, a fuel cell system and a related method of a third embodiment according to the present invention are described in detail mainly in conjunction with FIG. 4.

FIG. 4 is a view illustrating a structure of the fuel cell system equipped with the combustor and the fuel reforming device of the presently filed embodiment.

In FIG. 4, a different point between the presently filed embodiment and the first embodiment resides in a structure that additionally includes a second combustor 13 which is disposed in a downstream stage of the fuel cell 1 for combusting the exhaust gases emitted therefrom, a combustion exhaust gas line 15 disposed in a downstream stage of the combustor 13, a heat exchanger 16 for heat-exchange between the combustion exhaust gas and air, and a heating gas line 20 that introduces air, which is heated in the heat exchanger 16, into the heating gas intake port 12, whereupon the air heated in the heat exchanger 16 is in turn supplied to the premixer 10 as the heating gas. Also, since the heating gas is composed of the heated air, the premixer 10 has no air supply port 7 like the one shown in FIG. 1. Other structures are similar to those of the first embodiment and, so, like parts bear the same reference numerals to omit redundant description. Also, the startup method of the fuel cell system of the presently filed embodiment is similar to that of the first embodiment.

In particular, the presently filed embodiment takes the form of a structure, which does not necessarily require steam for reforming reaction, wherein the heated air is utilized as the heating gas. The fuel cell 1 and the combustor 13 are connected to one another through the anode exhaust gas line 5 and the cathode exhaust gas line 6 through which the anode exhaust gas (off-gas) and the cathode exhaust gas (off-gas) are supplied to the combustor 13, respectively. The combustor 13 combusts the hydrogen contained in the anode exhaust gas and the oxygen contained in the cathode exhaust gas, with resulting the combustion gas being introduced into the heat exchanger 16 through the combustion gas line 15. In the heat exchanger 16, the heat-exchange takes place between the combustion exhaust gas and the air to heat the air. Then, such heated air is introduced from the heating gas intake port 12 to the premixer 10 through the combustion gas recirculation line 14. On one hand, the combustion gases used for the heat-exchange are exhausted through the combustion gas exhaust line 15′.

According to the presently filed embodiment set forth above, the air is used as the heating gas, it is possible to avoid the excessive constituents in the combustion gases from being supplied to the reformer.

Further, in case of the reformer requiring no steam, of course, it is convenient to omit to supply the moisture contained in the exhaust gases for the reforming.

(Fourth Embodiment)

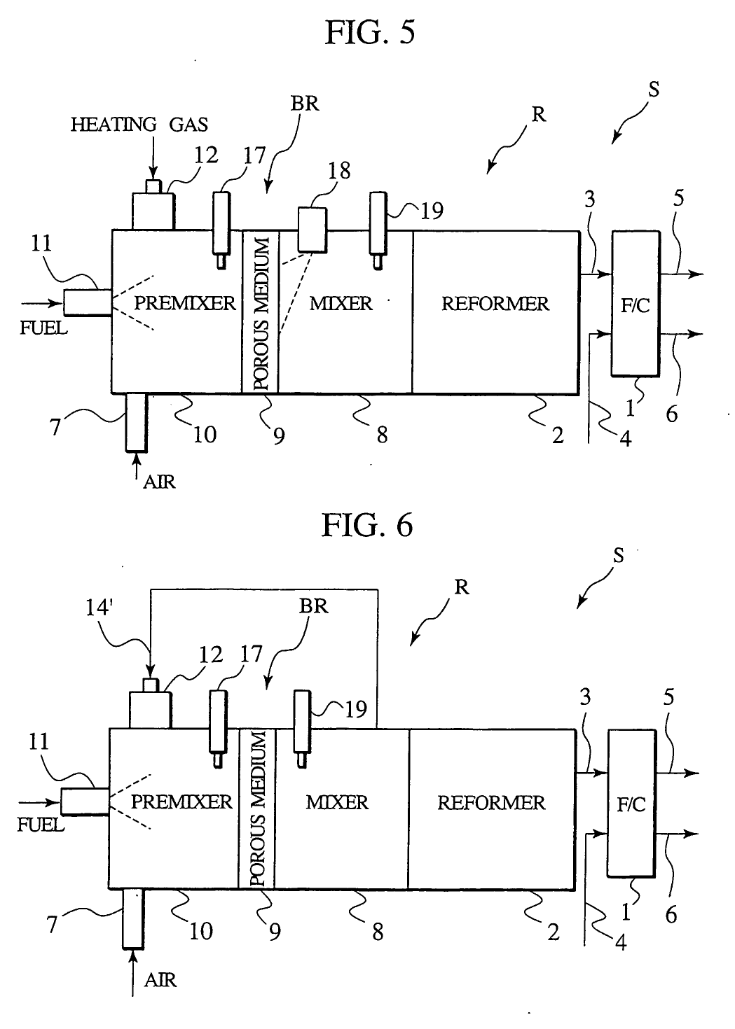

Next, a combustor, a fuel reforming device, a fuel cell system and a related method of a fourth embodiment according to the present invention are described in detail mainly in conjunction with FIG. 5.

FIG. 5 is a view illustrating a structure of the fuel cell system equipped with the combustor and the fuel reforming device of the presently filed embodiment.

In FIG. 5, a different point between the presently filed embodiment and the first embodiment resides in that the reformer 2 takes the form of a structure which typically perform steam reforming and the mixer 8 is provided with a water supply unit 18 that injects water against the porous medium 9. Thus, it is said that a fuel reforming device R is structured to enable the porous medium 9 to effectively evaporate the water to allow steam, required for steam reforming, to be supplied. Other structures are similar to those of the first embodiment and, so, like parts bear the same reference numerals to omit redundant description. Also, the startup method of the fuel cell system of the presently filed embodiment is similar to that of the first embodiment.

In particular, in the presently filed embodiment, the fuel is combusted in the premixer 10 and its resulting combustion heat quantity is utilized for gasifying the water injected from the water supply unit 18. In order for the water to be gasified, it is useful to increase the surface area so as to speed up the gasification speed. To this end, the water supply is carried out in a sprayed form against the porous medium 9. Even in the existence of the water splashed over the surface of the porous medium 9, since the porous medium 9 is heated through the combustion, the water tends to be adequately evaporated and gasified over the surface of the porous medium 9.

Further, by achieving combustion in the premixer 10 in a fuel-rich region higher than a theoretical air-fuel mixture, fuel vapor can also be generated. Thus, by mixing the fuel vapor, the steam generated by the porous medium 9, and additionally the air supplied from the air supply port 7, it is possible to supply the mixture gas, required for the steam reforming, to the reformer 2. Of course, since the air is mixed in the mixture gas prior to being introduced into the reformer 2, such steam reforming may be auto-thermal reaction which employs the steam reforming reaction and the partial oxidizing reaction.

Furthermore, in a case where the reforming reaction in the normal operation mode takes the steam reforming reaction that mainly utilizes the steam in the combustion gas, although the steam can not be rapidly supplied after the stoppage of the fuel cell system, the normal operation mode in the presently filed embodiment makes it possible to rapidly startup the reformer provided that the reformer is maintained at a temperature required for the steam reforming.

According to the presently filed embodiment set forth above, in case of the reformer achieving the steam reforming, the water can be sufficiently supplied to the reformer for the steam reforming. Consequently, it becomes possible to rapidly startup the reformer under a situation where the reformer remains at a high temperature such as a case where the reformer is continuously operated whereupon after the reformer is interrupted for a short time interval, the reformer is started up again.

Moreover, in an event that the combustion takes place in the premixer at the fuel-rich side richer in fuel than the theoretical air-fuel mixture to allow resulting the combustion heat to gasify the water into the steam to be mixed in the mixture gas whereupon the mixture gas is supplied to the reformer, the gases to be supplied contain the fuel vapor and the steam, and these gases are usable for the steam reforming reaction.

Also, the presence of the air mixed in the mixture gas prior to being introduced into the reformer can be also utilized in the auto-thermal reaction.

(Fifth Embodiment)

Next, a combustor, a fuel reforming device, a fuel cell system and a related method of a fifth embodiment according to the present invention are described in detail mainly in conjunction with FIG. 6.

FIG. 6 is a view illustrating a structure of the fuel cell system equipped with the combustor and the fuel reforming device of the presently filed embodiment.

In FIG. 6, a different point between the presently filed embodiment and the first embodiment resides in a structure that additionally includes a combustion gas supply line 14′ for introducing combustion gas from the mixer 8 into the heating gas intake port 12. Other structures are similar to those of the first embodiment and, so, like parts bear the same reference numerals to omit redundant description. Also, the startup method of the fuel cell system of the presently filed embodiment is similar to that of the first embodiment.

In particular, in the presently filed embodiment, a part of combustion gas emitted from the mixer 8 is introduced into the premixer 10 as the heating gas through the combustion gas recirculation line 14′ and it resulting heat quantity is utilized for the gasification of the fuel by means of the porous medium 9 to obtain the mixture gas.

According to the presently filed embodiment set forth above, by the use of a part of the combustion gas generated in the mixer as the heating gas, a simple structure can be realized that enables the heating gas to be supplied without the use of a new heating device.

The entire content of a Patent Application No. TOKUGAN 2002-161629 with a filing date of Jun. 3, 2002 in Japan are hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

### INDUSTRIAL APPLICABILITY

As previously mentioned, a combustor is provided with a premixer mixing fuel and heating gas, a mixer combusting fuel and heating gas mixed in the premixer, and a porous medium disposed between the premixer and the mixer. Here, a reformer can be disposed downstream of the combustor, with the combustor and the reformer, forming a fuel reforming device. Also, a fuel cell can be disposed downstream of the reformer to form a fuel cell system, with the fuel reforming device. Due to such a structure, it is possible to restrain the production of the nitrogen oxides. As a result, the combustor, the fuel reforming device and the fuel cell system including the porous medium can be applied to a fuel cell powered vehicle and electric power generators for industrial or domestic uses, with such applications being expected in a wide range.

1. A combustor comprising:
a premixer mixing fuel and heating gas;
a mixer combusting the fuel and the heating gas mixed in the premixer; and
a porous medium disposed between the premixer and the mixer, the fuel and the heating gas mixed in the premixer being supplied to the mixer through the porous medium.

2. The combustor according to claim 1, wherein the fuel is liquid, and the premixer is operative to achieve diffusion combustion between the fuel and air for warming up the porous medium and subsequently to interrupt the diffusion combustion whereupon the premixer supplies the fuel and the heating gas to the mixer through the porous medium to allow the mixer to combust the fuel and the heating gas.

3. The combustor according to claim 1, wherein the premixer includes a first igniter source that allows diffusion combustion between the fuel and air, and the mixer includes a second igniter source that allows combustion between the fuel and the heating gas.

4. The combustor according to claim 1, wherein the heating gas is gas resulting from combustion of the fuel.

5. The combustor according to claim 4, wherein the heating gas is gas resulting from a part of the fuel being combusted in the mixer.

6. The combustor according to claim 1, wherein the heating gas is heated air.

7. A fuel reforming device comprising:
a premixer mixing fuel and heating gas;
a mixer combusting the fuel and the heating gas mixed in the premixer;
a porous medium disposed between the premixer and the mixer, the premixer, the fuel and the heating gas mixed in the premixer being supplied to the mixer through the porous medium, and the mixer and the porous medium forming a first combustor; and
a reformer disposed downstream of the first combustor for generating hydrogen-rich gas.

8. The combustor according to claim 7, wherein the fuel is liquid, and the premixer is operative to achieve diffusion combustion between the fuel and air for warming up the porous medium and subsequently to interrupt the diffusion combustion whereupon the premixer supplies the fuel and the heating gas to the mixer through the porous medium to allow the mixer to combust the fuel and the heating gas to warm up the reformer.

9. The combustor according to claim 7, wherein the heating gas is gas resulting from combustion of the fuel.

10. The combustor according to claim 9, wherein the heating gas is gas resulting from a part of the fuel being combusted in the mixer.

11. The combustor according to claim 7, wherein the heating gas is heated air.

12. The combustor according to claim 11, further comprising a water supply unit supplying water to the porous medium,
wherein the water is vaporized into steam and the steam is supplied to the reformer.

13. A fuel cell system comprising:
a premixer mixing fuel and heating gas;
a mixer combusting the fuel and the heating gas mixed in the premixer;
a porous medium disposed between the premixer and the mixer, the fuel and the heating gas mixed in the premixer being supplied to the mixer through the porous medium, and the premixer, the mixer and the porous medium forming a first combustor;
a reformer disposed downstream of the first combustor for generating hydrogen-rich gas; and
a fuel cell disposed downstream of the reformer.

14. The combustor according to claim 13, wherein the fuel is liquid, and the premixer is operative to achieve diffusion combustion between the fuel and air for warming up the porous medium and subsequently to interrupt the diffusion combustion whereupon the premixer supplies the fuel and the heating gas to the mixer through the porous medium to allow the mixer to combust the fuel and the heating gas to warm up the reformer.

15. The combustor according to claim 13, wherein the heating gas is gas resulting from combustion of the fuel.

16. The combustor according to claim 15, further comprising a second combustor disposed downstream of the fuel cell,
wherein the heating gas is gas resulting from a part of the fuel combusted in the second combustor.

17. The combustor according to claim 13, wherein the heating gas is heated air.

18. The combustor according to claim 13, further comprising a second combustor disposed downstream of the fuel cell and a heat exchanger disposed downstream of the second combustor,
wherein the heated air is the air heated by heat-exchange in the heat exchanger between combustion gas, flowing from the second combustor, and air.

19. The combustor according to claim 13, further comprising a water supply unit supplying water to the porous medium,
wherein the water is vaporized into steam and the steam is supplied to the reformer by which steam reforming is performed to for the fuel that is supplied to the fuel cell.

20. A method of starting up a fuel cell system, comprising:
providing a fuel cell system equipped with a premixer mixing fuel and heating gas, a mixer combusting the fuel and the heating gas mixed in the premixer, a porous medium disposed between the premixer and the mixer, a reformer disposed downstream of the mixer to produce hydrogen-rich gas and a fuel cell disposed downstream of the reformer;
warming up the porous medium by achieving diffusion combustion between the fuel and air in the premixer and, subsequently, interrupting the diffusion combustion; and
warming up the reformer by combusting the fuel and the heating gas in the mixer, while supplying the fuel and the heating gas into the mixer through the premixer and the porous medium.
